(19) United States
(12) Patent Application Publication
(10) Pub. No.: US 2025/0319810 A1
(43) Pub. Date: Oct. 16, 2025

(54) Method For Operating At Least One Luminaire Of A Vehicle And Luminaire

(71) Applicant: Volkswagen Aktiengesellschaft, Wolfsburg (DE)

(72) Inventors: Bernhard KREIPE, Hannover (DE); Jörg SPEH, Braunschweig (DE)

(73) Assignee: Volkswagen Aktiengesellschaft, Wolfsburg (DE)

(21) Appl. No.: 19/176,979

(22) Filed: Apr. 11, 2025

(30) Foreign Application Priority Data
Apr. 13, 2024 (EP) 24 170 123.4

(51) Int. Cl. B60Q 1/14; H05B 47/155

(52) U.S. Cl. CPC B60Q 1/143; H05B 47/155; B60Q 2300/42

(57) ABSTRACT

Method for operating at least one lighting apparatus of a vehicle, in particular a headlight and/or a floor projector of the vehicle, for outputting a light distribution on the basis of a light image, which is at least regionally generated by a light image generating circuit of the vehicle, depending on at least one non-spatially resolved light image variable, wherein the at least one light image variable is characteristic of at least one region of the light image to be generated, for example of the entire light image to be generated. The light image generating circuit receives the at least one light image variable from a light image variable determination circuit of the vehicle, which is spaced apart therefrom and is in particular a processor- and/or controller-based light image variable determination circuit, in order to at least regionally generate the light image.

### CROSS-REFERENCE TO RELATED APPLICATIONS

This application claims priority to European Patent Application EP 24 170 123.4, filed on Apr. 13, 2024 with the European Patent Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The present disclosure relates to a method for operating at least one lighting apparatus of a vehicle, in particular a headlight and/or a floor projector of the vehicle, for outputting a light distribution on the basis of a light image, in particular generated in real time, and to a lighting apparatus, in particular a headlight and/or a floor projector, for a vehicle. The present teachings further relates to a vehicle comprising a lighting apparatus and to an arrangement of a lighting apparatus and a light image variable determination circuit, in particular a processor- and/or controller-based one, for determining at least one light image variable and for transmitting the at least one light image variable to the lighting apparatus or to a light image generating circuit of the lighting apparatus for generating the light image.

Some high-resolution headlights may be actuated on a pixel basis, i.e., via video streaming, by an external control unit. This includes the algorithm for generating an image on the basis of sensor data as well as rendering for calculating the individual images. Video streaming increases bandwidth requirements directly proportional to resolution. Cost-effective network technologies can therefore only be used at low resolutions.

A decentralized approach, in which a control unit is located in each luminaire and in which actuation is carried out by means of signal-based communication via a simple vehicle bus (CAN), requires high costs because one control unit is required for each luminaire. Another disadvantage of this approach is more complex synchronization and very limited update capabilities, especially for functions on demand/online remote updates.

In a centralized approach with actuation by an external control unit via uncompressed video streaming, the network technology costs disadvantageously increase with the resolution of the luminaire. Another disadvantage is the high latency for image transmission.

A disadvantage of a centralized approach with actuation by an external control unit via video streaming with compression is that the compression factor is limited, especially with lossless compression. For high compression rates, a lot of computing power is required for decompression in the luminaire. Furthermore, this results in moderate latency for image transmission.

### SUMMARY

A need exists to provide a lighting apparatus and a method for operating a lighting apparatus which offer cost-efficient fulfillment of a high-resolution lighting function by the lighting apparatus while at the same time providing low latency.

The need is addressed by the subject matter of the independent claim(s). Embodiments of the invention are described in the dependent claims, the following description, and the drawings.

### BRIEF DESCRIPTION OF THE DRAWINGS

FIG. 1 is a representation, according to an embodiment, of the use of a lighting apparatus of a vehicle according to the teachings herein;

FIG. 2 is a schematic representation, according to an embodiment, of a control apparatus for a lighting apparatus according to the teachings herein;

FIG. 3a is a schematic representation of an arrangement of a light image variable determination circuit and a light image generating circuit of a lighting apparatus; and

FIG. 3b is a schematic representation of an arrangement according to the teachings herein of a light image variable determination circuit and a light image generating circuit of a lighting apparatus.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

Some embodiments provide operating at least one lighting apparatus (also referred to as ‘light’ or ‘luminaire’ herein) of a vehicle, in particular a headlight and/or a floor projector of the vehicle, for outputting a light distribution on the basis of an (in particular spatially resolved) light image generated in particular in real time.

The lighting apparatus for example comprises several pixels for emitting light in order to achieve a variable light distribution (to be output). For this purpose, the pixels of the lighting apparatus can each be actuated individually depending on certain actuation parameters, such as a brightness and/or a color value of the pixel.

This means that the lighting apparatus, for example a headlight, can be used to implement further lighting functions in addition to low and high beam, for example, such as cornering lights or glare-free high beam.

A pixel is, in particular, the smallest actuatable optical unit of the lighting apparatus in order to achieve a change in the light distribution that is emitted by the lighting apparatus and/or is to be emitted by the lighting apparatus. In this case, each pixel can be designed, for example, as a single illuminant (such as a single light source) such as an LED (light-emitting diode), and/or a pixel of a segmented LED (micropixel LED), and/or as a micromirror, and/or as a display or a pixel of a reflective or transmissive liquid crystal display (LCD, LCoS), and/or as a shutter, and/or as an aperture, and/or as an optical apparatus for modifying and/or changing and/or absorbing individual light rays. This has the benefit that the light distribution can be variably adjusted, and different lighting functions can be realized.

The lighting apparatus is for example a high-resolution lighting apparatus (pixel luminaire), i.e., a lighting apparatus with more than 1,000 pixels, or for example more than 4, 000 pixels (for example at least 10,000 pixels) for emitting the light (by illuminants, such as light sources) in a manner controllable by the individual pixels. This offers the benefit that such high-resolution lighting apparatuses can realize high-resolution lighting functions (i.e., when said functions are realized, more than 1,000 pixels, or for example more than 4,000 pixels, or for example at least 10,000 pixels, of the lighting apparatus are used, in particular at the same time).

The lighting apparatus for example has at least 10,000 pixels, or for example at least 15,000 pixels, or for example at least 25,000 pixels. The proposed method is particularly applicable to lighting apparatuses with even higher pixel counts, such as at least 100,000 pixels.

An example of such a high-resolution lighting function is an adaptive front light (masking) in which a headlight range adjuster is for example controlled, and/or in which a light distribution (the light distribution emitted by the lighting apparatus, in particular the headlight) is changed depending on detected oncoming traffic and/or a vehicle driving ahead (in particular recorded by a camera of the vehicle). In particular, the light distribution is masked, i.e., the light intensity at least in a portion is changed and/or reduced. As soon as no other road users are detected, the light “smoothly” switches back to high beam.

A further example of such a high-resolution lighting function is an adaptive front light (sign glare control or sign glare protection), in which the illumination of detected traffic signs is adjusted in order to prevent the driver from being dazzled by the reflection of the emitted light on the traffic sign, for example.

A further example of such a high-resolution lighting function is a lane light in which a region of the lane to be driven is illuminated (in the form of a light carpet).

A further example of such a high-resolution lighting function is dynamic cornering light in which a light distribution is pivoted depending on the curvature of the road.

A further example of such a high-resolution lighting function is a lane change warning light (“side assist”) which warns of a road user approaching an adjacent lane, in particular from behind (e.g. if the intention to change lanes is detected, e.g. if the activation of the lane change indicator is detected). Such a warning can be given, for example, by issuing a warning light in the form of a (solid) lane boundary between the vehicle's lane and the lane of the vehicle approaching from behind.

A further example of such a high-resolution lighting function is an orientation light, for example to indicate the vehicle width in a narrow space, e.g. a construction site region, in which the width and position of the vehicle is highlighted, for example by light emitted onto the road (e.g. by two parallel linear light portions).

A further example of such a high-resolution lighting function is a marker light which draws the driver's attention to a critical situation at the road edge, such as one or more pedestrians, by illuminating them (comparatively more intensely).

For example, the luminance function to be fulfilled by the lighting function is dependent (at least temporarily) on the vehicle's surroundings (as in the examples mentioned above). For example, a sensor device of the vehicle for recording the vehicle's surroundings records the vehicle's surroundings.

For example, the sensor device for recording a vehicle's surroundings is selected from a group of sensors which comprise a (color) camera, a front camera, a rear camera, an infrared camera, LiDAR (abbreviation for light detection and ranging or light imaging, detection and ranging), radar, ultrasonic sensors and the like, as well as combinations thereof. For example, the sensor device for recording a vehicle's surroundings generates spatially resolved (in particular 2D and/or 3D) sensor data (of the surroundings of the relevant vehicle).

For example, the lighting function is executed depending on the recorded sensor data.

(Lighting) algorithms are used to perform the actuation of the individual illuminants (e.g. the individual light sources) or the pixels and to determine the necessary control information, e.g. the brightness values and/or color values for each pixel (or illuminant). The light distribution, and/or the brightness value, and/or the color value, and/or the control information are calculated for each individual illuminant of the lighting apparatus or for each individual pixel of the lighting apparatus.

For example, a or the (spatially resolved) light image required to fulfill the lighting function is determined for a (specified and/or specifiable—for example by a user of the vehicle) lighting function to be fulfilled by the lighting apparatus.

For example, the light image is determined or calculated on the basis of sensor data (recorded by at least one sensor device of the vehicle).

The light image is in particular a spatially resolved light image which is in particular characteristic of a light distribution suitable for fulfilling the lighting function. The light image can, for example, indicate a light distribution suitable (and has been determined or established) for fulfilling the lighting function.

For example, the (spatially resolved) light image can indicate which regions of the surroundings or roadway and/or lane regions are to be illuminated with which color values and/or brightness values.

The light image is in particular spatially resolved in that it for example indicates a spatial and/or planar light distribution and/or an assignment of color and/or brightness values to a plurality of positions (arranged spatially or in a plane). In particular, the light image already has a particular color and/or brightness value for each of a plurality of positions.

The light image for example specifically specifies the color and/or brightness gradients of the light distribution to be output in a spatially resolved manner in order to fulfill the lighting function. “Specifically specify” is understood in particular to mean that these cannot only be obtained by calculation using a function or a calculation rule, for example, but that specific color and/or brightness values are specified.

The light image therefore for example depicts a spatially resolved representation of the color and/or brightness values.

The light image can be determined independently of the (specific hardware of the) lighting apparatus. For example, the light image may not be independent of the exact number of pixels and/or (spatial) arrangement of the pixels that are provided by the lighting apparatus. In this way, values for the actuation parameters (of the individual pixels) of the lighting apparatus can be determined on the basis of the light image. This offers the benefit that the light image can be determined independently of the specific configuration of the lighting apparatus. In particular, the light image can only be determined depending on the lighting function to be fulfilled.

The light image can have a higher or lower resolution than the lighting apparatus (number of pixels). It is conceivable that the values for the actuation parameters (of the individual pixels) of the lighting apparatus, such as brightness and/or color values, are determined by averaging (for example if the resolution of the light image is higher than the number of pixels of the lighting apparatus) and/or interpolation (for example if the resolution of the light image is lower than the number of pixels of the lighting apparatus). It is also conceivable that when determining the values for the actuation parameters, at least one or more optical properties of the lighting apparatus (such as refractive properties, and/or lens properties, and/or imaging properties, and/or aging of one or more illuminants such as several light sources) is/are taken into account.

The light image can, for example, indicate a brightness and/or color distribution which results from outputting the light distribution suitable and/or intended and/or determined for fulfilling the lighting function on a predetermined surface, for example on a vertical wall (at a predetermined distance from the lighting apparatus and with a predetermined orientation, in particular the orientation that the lighting apparatus has in the installed state in the vehicle).

However, it is also conceivable that the light image indicates the light distribution (suitable and/or intended and/or determined for fulfilling the lighting function) in a region of the lighting apparatus (for example in a region of the lighting apparatus in which the illuminants (e.g. light sources) or the pixels are arranged).

The light image can in particular describe or indicate a planar and/or spatial light distribution.

The light image is at least regionally and for example completely generated or calculated (in particular in a computer-implemented method step) by a light image generating circuit of the vehicle, in particular a processor- and/or controller-based one, depending on at least one non-spatially resolved light image variable, for example of a plurality of non-spatially resolved light image variables.

In this context, “non-spatially resolved” is understood in particular to mean that a specific assignment, in particular a “one-to-one assignment” between a position or a location and a light distribution variable such as a brightness and/or color value, has not been specified yet.

The at least one light image variable is characteristic of at least one region of the light image to be generated, for example of the entire light image to be generated. Thus, the light image can be derivable from the at least one light image variable, for example the plurality of light image variables (in particular without further variables being required which are characteristic of the light distribution to be generated to fulfill the lighting function and which are for example independent of the lighting apparatus).

For example, the light image variable could specify a regulation on how the light image can be created or calculated. For example, the light image variable could indicate which roadway and/or lane region is to be illuminated and/or lit up in which way and with which color gradient, but without specifying spatially resolved color and/or brightness values.

For example, geometric contours could be specified by the light image variable(s) and/or these could be characteristic thereof, wherein the geometric contour (in each case) specifies a (geometric) region of the light image to be produced in which the light image is to be produced in accordance with a uniform lighting regulation. For example, the (uniform) lighting regulation differs from at least one further lighting regulation, particularly from a plurality of further lighting regulations, by means of which at least one other region of the light image is generated.

The lighting regulation may, for example, relate to homogeneous lighting/illumination/light output with, in particular, the same intensity or the same brightness and/or color value. However, it can also relate to a predefined brightness and/or color gradient (whose values change within a predefined range of values according to a predefined function, for example depending on the position).

For example, geometric contours could specify boundaries of a region to be (e.g. uniformly and/or more and/or less intensely) illuminated, such as the above-mentioned light carpet and/or a traffic sign to be illuminated, and/or to reduce the glare from signs.

The light image variables can thus specify a design of an edge (hard edge, soft edge) of an output light object, a design of a light-dark boundary or a light-dark boundary region, a design of a transition between at least two light objects arranged next to one another and/or one above the other, a design of a run-out of a light distribution to be output, shading, a size specification (length and/or width) of a light object or light distribution to be output, a scale of a light object to be output, a gradient of a brightness and/or color distribution. A light object can, for example, be a geometric shape which is, for example, to be output (i.e. by being illuminated and/or projected) onto a roadway region (e.g. by illumination and/or projection using the lighting apparatus). A light image variable can further indicate a texture (type of brightness and/or color distribution within the contour, such as hatching, uniform brightness and/or color values, color gradient and/or brightness gradient within the contour).

It is also conceivable that the light image variable(s) indicate(s) the position and/or type and/or geometric details (width, height) and/or motion quantities (speed, acceleration) of an object detected in the vehicle's surroundings, on which the fulfillment of a lighting function to be fulfilled by the lighting apparatus depends.

For example, the position of oncoming traffic, the type of vehicle and the speed of the oncoming traffic can indicate so that a gap (corresponding to a predetermined shape) in the oncoming traffic can be determined (dynamically) from a surrounding area illuminated by a high beam.

It is also conceivable that the light image variable(s) indicate(s) the position and geometric details (width, height) of a traffic sign (detected in the vehicle's surroundings) to be marked and/or illuminated and/or objects to be marked, such as a lane boundary.

For example, a luminous variable also indicates a geometric shape of a light distribution to be emitted on the roadway (e.g. asymmetrical shape of a high beam) or variables characteristic thereof.

According to the teachings herein, the light image generating circuit receives the at least one light image variable (and for example the plurality of light image variables) from a light image variable determination circuit of the vehicle, which is spaced apart from said light image generating circuit and is in particular processor and/or controller-based, for at least regionally generating the light image.

In other words, a method for actuating luminaires with outsourced light image generation (edge light image generation) is proposed. This beneficially yields placement on two independent (computing) devices.

For example, the at least one light image variable is or will be determined by a light image variable determination circuit (of the vehicle) which (described in more detail below) is in particular processor-and/or controller-based.

For example, the light image is generated in two steps which are carried out on two independent computing devices. For example, in a first step, the at least one light image variable or the plurality of light image variables is determined. For example, in the second step, the light image is determined from the light image variables.

For example, the two steps are divided up such that the amount of data for the at least one light image variable and/or the plurality of light image variables required to generate the light image is smaller, for example by a factor of 10, or for example at least a factor of 100, or for example at least a factor of 1000, than the amount of data for the generated light image.

For example, the two steps are divided up in such a way that the amount of data for the at least one light image variable and/or the plurality of light image variables required to generate the light image is not dependent on the number of pixels of the lighting apparatus.

In particular, the at least one light image variable or the plurality of light image variables is/are selected in such a way that they are independent of the resolution of the light image to be generated of the number of pixels of the lighting apparatus.

This beneficially allows a communication device with a lower bandwidth to be used to transmit the light image variable(s).

A reduction in bandwidth requirement enables the use of cost-effective vehicle networks.

The transmission of the light image variable(s) instead of the light image to be generated further beneficially means there is no dependency on the resolution.

The latency reduction achieved in this way enables fast compensation algorithms, e.g. for image stabilization applications.

In some embodiments, the lighting apparatus comprises the light image generating circuit. For example, the light image generating circuit is arranged within a housing or on the housing of the lighting apparatus. The light image generating circuit can be attached directly to the housing of the lighting apparatus and/or touch the housing of the lighting apparatus. This offers the benefit that the light image generated by the light image generating circuit no longer has to be transmitted across the vehicle to the lighting apparatus, but can be used to directly actuate the pixels of the lighting apparatus. This beneficially eliminates the need for communication devices with sufficient bandwidth for transmitting the light image.

For example, the light image generating circuit together with the lighting apparatus forms a structural unit which can be mounted and/or replaced, in particular as a common structural unit or component. For example, the light image variable determination circuit is not part of this structural unit.

For example, the light image generating circuit represents a network node (for example an end point) of an (in particular Ethernet-based) communication network of the vehicle.

In some embodiments, the light image generating circuit generates the region of the light image and for example the entire light image by means of rendering on the basis of the at least one light image variable and for example on the basis of the plurality of light image variables. This offers the benefit that the rendering steps, which generate spatially resolved data and, depending on the resolution, generate a large amount of data, are carried out by a computing device in the lighting apparatus.

However, those (computationally intensive) calculation steps which, however, do not yet generate data volumes that are dependent on the resolution can be carried out by a computing device at another location in the vehicle. For example, a computing device can be used for these calculation steps which also carries out other data processing steps for other vehicle functions so that a separate computing device having the necessary processor power is not required for this.

For example, at least one rendering step is carried out and for example, all rendering steps required to generate the light image are carried out by the light image generating circuit.

In other words, a method for actuating luminaires with outsourced rendering for generating light images (edge rendering) is proposed.

In some embodiments, the at least one light image variable and for example the plurality of light image variables are characteristic of a geometric description of the light image to be generated. For example, the light image variables are selected such that the light image to be generated can be generated (in particular only) depending thereon by rendering steps.

For example, the light image to be generated can be broken down into (geometrically simple) light objects which are geometrically easy to describe (and can therefore be described using variables having smaller amounts of data). For example, regions of the light image to be generated are combined and described by means of a single (geometric) (light) object.

A geometric (light) object can be triangles, rectangles, squares, circles, trapezoids and the like.

In some embodiments, the light image variable determination circuit determines at least one scene object (or light object) and/or scene element and for example a plurality of scene objects (or light objects) and/or scene elements in order to generate the light image and/or to generate the at least one light image variable and for example the plurality of light image variables.

This beneficially yields a separation of algorithm to the scene calculation and rendering of the light image and enables them to be placed on two independent computing units that are connected via a vehicle network.

A scene can in particular be a virtual spatial model in which a light distribution determined to fulfill the lighting function and/or the roadway and/or lane, objects from the vehicle's surroundings (in particular their material properties, light sources), as well as the position and light emission direction of the lighting apparatus (or the vehicle's lighting apparatuses) and/or surrounding areas to be marked and/or surrounding objects are specified.

A different way of splitting the algorithm and rendering components is also conceivable, e.g. partial placement of algorithm components in the luminaire. This beneficially yields a loose connection of the algorithm and rendering.

The calculation of the light image in the luminaire or lighting apparatus is for example carried out by software rendering on a microcontroller (MCU), system-on-chip (SoC) or ASIC.

It is also conceivable to calculate the rendering on a graphics processing unit (GPU)/microprocessor unit (MPU). By way of comparison, software rendering on an MCU/SoC is the most cost-effective and flexible solution.

In some embodiments, the at least one light image variable and for example the plurality of light image variables is/are each characteristic of a command for generating a scene object and/or of a command list for generating a scene. This can beneficially enable the transmission of image content between the computing units via a command list over a vehicle network.

For this purpose, the scene elements (objects) are for example calculated in an external/central control unit and transmitted to the luminaire via an interface as a command list via the vehicle bus (e.g. 10 MBit Ethernet). In the luminaire, the light image is calculated (rendered) from the objects. This means that the light image can be transmitted with low bandwidth requirements and, in particular, independently of the resolution.

For example, a command list is transmitted in a (common) data packet over the vehicle network.

In some embodiments, the at least one light image variable and for example the plurality of light image variables, particularly for example the data characteristic of a command list for generating a scene, is or are transmitted to the light image generating circuit via a vehicle network, for example via a vehicle bus.

For example, the light image variable(s) is/are transmitted to the light image generating circuit via a communication device which does not exceed a bandwidth of 10 Mbit/s, or for example 100 Mbit/s, at least partially (possibly also over the entire connection). For example, all the light image variables to be transmitted for generating the light image are transmitted to the light image generating circuit using a communication device which does not exceed a bandwidth of 10 Mbit/s, or for example 100 Mbit/s, at least partially.

For example, the at least one light image variable and for example all the light image variables (in particular as a common data packet, for example provided for transmission by the light image variable determination circuit) to be transmitted in order to generate the light image, which is in particular to be generated in real time, is/are transmitted to the light image generating circuit at a data rate which does not exceed 10 Mbit/s or for example 100 Mbit/s.

The present disclosure is further directed to a lighting apparatus (also referred to herein as ‘light’ or ‘luminaire’), in particular a headlight and/or a floor projector, for a vehicle for outputting a light distribution on the basis of a (spatially resolved) light image, in particular generated in real time.

In this case, the light image is generated at least regionally and for example completely by a light image generating circuit, in particular a processor- and/or controller-based one, of the lighting apparatus depending on at least one non-spatially resolved light image variable, for example of a plurality of non-spatially resolved light image variables.

The at least one light image variable is characteristic of at least one region of the light image to be generated, for example of the entire light image to be generated.

According to the teachings herein, the lighting apparatus has an interface for receiving the at least one light image variable and for example the plurality of light image variables.

It is therefore also proposed within the framework of the lighting apparatus according to the teachings herein that some of the data processing steps for generating the light image are carried out by a data processing device external relative to the lighting apparatus (in particular outside the lighting apparatus), while the completion of the light image is carried out by the lighting apparatus.

Here, too, it is beneficial to propose placing the generation of the light image on two different computing devices.

For example, the lighting apparatus is configured, suitable and/or intended to carry out the method described above and in particular all the method steps already described above in connection with the lighting apparatus (or the light image generating circuit) individually or in combination with one another. Conversely, the method can be provided all the features described in the context of the lighting apparatus individually or in combination with one another.

In some embodiments, the light image generating circuit is a rendering device for carrying out at least one rendering process and for example for carrying out all the rendering steps to be carried out when generating the light image. Here, too, edge rendering is beneficially accordingly proposed, i.e., luminaire actuation with outsourced rendering for generating light images.

In some embodiments, the light image generating circuit is selected from a group of computing devices which comprises microcontrollers (MCUs), systems-on-chips (SoCs), ASICS (application-specific integrated circuits) and the like, as well as combinations thereof. This offers the benefit that, compared to the central control unit, comparatively cost-efficient computing devices can be selected for the lighting apparatus.

Additionally or alternatively, it is also conceivable that the light image generating circuit is selected from a group of computing devices which includes MPUs (abbreviation for microprocessor unit), GPUs (abbreviation for graphics processing unit), FPGAs (acronym for field-programmable gate array) and the like, as well as combinations thereof.

The present disclosure further relates to an arrangement of a light image generating circuit of a lighting apparatus as described above and a light image variable determination apparatus, in particular a processor- and/or controller-based one, for determining the at least one light image variable, for example the plurality of light image variables, and for transmitting the at least one light image variable, for example the plurality of light image variables, to the light image generating circuit.

According to the teachings herein, the light image variable determination circuit is arranged outside the lighting apparatus, and/or externally relative to the lighting apparatus, and/or at a distance from the light image generating circuit (and/or at a distance from the lighting apparatus). It is conceivable, for example, that the light image variable determination circuit is connected to the light image generating apparatus by a wired communication device whose length exceeds at least 1 m, or for example at least 2 m, or for example 5 m. For example, the light image variable determination circuit is arranged outside a housing of the lighting apparatus. For example, the light image variable determination circuit is arranged outside a housing for enclosing a plurality of illuminants of the lighting apparatus and/or a driver for actuating the plurality of illuminants (such as LEDs).

In some embodiments, the light image variable determination circuit and the light image generating circuit can be operated independently of one another. For example, the light image variable determination circuit and the light image generating circuit are supplied with energy (current) independently of one another or can be supplied with energy (current) independently of one another.

The present disclosure further relates to a vehicle, in particular a motor vehicle, comprising at least one lighting apparatus as described above and light comprising a image variable determination circuit, in particular a processor- or controller-based one, for determining the at least one light image variable, for example the plurality of light image variables, and for transmitting the at least one light image variable, for example the plurality of light image variables, to the light image generating circuit.

The light image variable determination circuit is arranged outside the lighting apparatus and/or at a distance from the light image generating circuit. For example, the light image variable determination circuit is not arranged directly on the lighting apparatus. For example, the light image variable determination circuit is not attached to a housing of the lighting apparatus. For example, the light image variable determination circuit does not contact the lighting apparatus. For example, further components, in particular further electronic components (for example at least one zone controller and/or switch and/or gateway of a/the communication device) of the vehicle, which are not part of the lighting apparatus, are arranged between the light image variable determination circuit and the lighting apparatus.

For example, the light image variable determination circuit is a computing device of the vehicle that is external relative to the lighting apparatus.

For example, the vehicle has an arrangement as described above in accordance with an embodiment.

In some embodiments, the light image variable determination circuit is a (central) computing device and/or a central control unit (controller/processor) of the vehicle.

For example, the light image variable determination circuit (for example as a central computing device) is suitable and intended for determining the light distribution required and/or suitable and/or intended for fulfilling the (predetermined and/or predeterminable) lighting function to be fulfilled by the lighting apparatus (in particular within the framework of a computer-implemented method step).

For example, this light distribution is determined on the basis of the sensor data recorded and/or generated by the at least one sensor device of the vehicle (described above).

For example, the at least one light image variable and for example the plurality of light image variables are determined on the basis of the sensor data recorded and/or generated by the at least one sensor device of the vehicle (described above).

For example, the light image variable determination circuit is suitable and intended to receive the sensor data and/or retrieve it from storage devices (such as the at least one sensor device) in the vehicle.

The central computing device and/or the central control unit of the vehicle is/are for example part of a central vehicle electronic system which actuates one or more lighting apparatuses (such as headlights and/or floor projectors) of the vehicle.

Furthermore, it can be provided that the central computing device and/or the central control unit is/are electrically connected directly or indirectly to further electronic components of the vehicle, such as a sensor device (as described above), for example to one or more cameras, and/or to a radar sensor, and/or to devices for recording the speed and/or steering direction.

In some embodiments, the lighting apparatus is an in particular high-resolution lighting apparatus having more than 1,000 pixels, for example more than 4,000 pixels, for light emission controllable pixel by pixel.

The vehicle comprises a communication device via which the at least one light image variable, and for example the plurality of light image variables, can be transmitted to the light image generating circuit. The communication device is a CAN bus and/or an Ethernet data connection. For example, this communication device has a bandwidth that does not exceed a 10 Mbit bandwidth, for example a 100 Mbit bandwidth, at least partially.

The light image variable determination circuit (in particular designed as a central computing device and/or as a central control unit) can be connected to the lighting apparatus (for transmitting the at least one light image variable) via end-to-end Ethernet communication.

Alternatively, the light image variable determination circuit (in particular designed as a central computing device and/or as a central control unit) can be connected to the lighting apparatus (for transmitting the at least one light image variable) via a zone architecture with a gateway.

The communication device for example further comprises one or more electronic components such as a switch and/or a zone controller (for controlling the power distribution in the vehicle).

For example, the light image variable determination circuit (in particular designed as a central computing apparatus and/or as a central control unit) can be connected via a switch to a zone controller (by wires and for example via an Ethernet connection), in particular for transmitting the at least one light image variable.

The switch is in turn connected (by wires and for example via an Ethernet connection) to a zone controller.

The zone controller can be connected to the lighting apparatus (by wires and for example via an Ethernet connection). In this case, the zone controller can be designed as a switch, for example, so that a gateway is not required.

In some embodiments, the zone controller is connected to the lighting apparatus via a CAN communication link (CAN FD). In this case, protocol conversion in the gateway is required.

The high-resolution lighting apparatus is particularly suitable and intended for emitting light into the environment of the lighting apparatus pixel-by-pixel and in a manner controlled by the individual pixels. In particular, the lighting apparatus is suitable and intended to generate an image formed from a plurality of light pixels. As a result, the lighting apparatus is suitable and intended to project patterns of substantially any shape.

The (high-resolution) lighting apparatus for example has at least one light modulator which is for example designed as a DMD (digital mirror device), LCD (liquid crystal display) and/or as a liquid crystal on silicon (LCoS). In this case, individual image elements of the light modulator can for example be actuated, as a result of which light distributions that follow a pattern of substantially any shape can be generated. For example, the (high-resolution) lighting apparatus has an imaging optical system which is arranged in the optical beam path between a light source and the light modulator. For example, the high-resolution light module has a projection optical system for projecting the light modulated by the light modulator onto the projection surface.

For example, the (high-resolution) lighting apparatus comprises a micropixel LED which in particular comprises several thousand individually actuable pixels. It is also conceivable to use micropixel LEDs with between one thousand and twenty thousand pixels, for example between four and twenty thousand pixels. Such a high-resolution lighting apparatus is suitable and intended to output content in very high resolution. For example, the high-resolution lighting apparatus has a projection optical system arranged downstream of the micropixel LED in the optical emission direction.

A matrix module is in particular a light emitting apparatus comprising a matrix of individually controllable light-emitting pixel elements for generating an original light image formed from light pixels. For example, the matrix module, in particular the LED matrix module, has a plurality of light sources arranged in the form of a matrix, in particular LEDs, and a circuit board equipped therewith. For example, the matrix module, in particular the LED matrix module, has at least one heat sink for cooling the heat generated during its operation, wherein the heat sink is for example connected to the circuit board so as to conduct heat. For example, each of the light sources, in particular each LED, is assigned a primary optical element for shaping and directing coupled-in light, into which light from the corresponding light source, in particular the corresponding LED, can be coupled. The matrix module for example has at least 8 and for example at least 100 individually activatable and/or individually actuable light segments.

Alternatively or additionally, the lighting apparatus can be a DLP projector (DLP for digital light processing), in particular with a DMD unit (DMD is an abbreviation for “digital micro mirror device”, an electronic component with micromirrors). In particular, each image point or pixel is generated by a single, actuable adjustable mirror. Depending on the tilted state of the particular adjustable mirror, the light can either be projected through a lens or blocked (especially in a light trap).

A DLP projector can also be implemented as a 3-chip projector in which each DMD chip is assigned a different color.

A DLP projector can have at least three light sources (such as LEDs) emitting light of different colors, the light emitted thereby being transmitted, in particular offset in time to one another, to a DMD unit, for example via a spectral coupler. The (monochrome) images output one after the other at short intervals create a full-color image in the human eye of a viewer.

A DLP projector can (alternatively also) be designed as a 1-chip projector. In this case, different colors can for example be generated by a rotating color wheel, and the radiation generated in this way is directed to a reflective DMD chip. An impression of a full-color image can arise due to perceptual inertia in the human eye caused by images produced in rapid succession.

The lighting apparatus is for example an external lighting apparatus of the vehicle, which in particular emits light into an external environment of the vehicle, for example onto a road region in the vehicle's surroundings. For example, the outdoor lighting apparatus can be a floor projector.

The lighting apparatus may be a front and/or rear light and/or a front and/or rear headlight.

However, it is also conceivable that the lighting apparatus is an interior lighting apparatus of the vehicle which emits light toward the interior of the vehicle (e.g. into the vehicle cabin).

The present disclosure further relates to a vehicle, in particular a motor vehicle, comprising at least one lighting apparatus as described above and for example at least two lighting apparatuses as described above for a vehicle according to one embodiment (for example arranged on different sides of the vehicle, such as the right or left, e.g. right and left headlights). The vehicle may in particular be a (motorized) road vehicle. For example, the vehicle comprises a (single) light image variable determination circuit, as described above. For example, the light image variable determination circuit determines for both lighting apparatuses the light image variables to be transmitted to the corresponding lighting apparatuses.

The vehicle may be a motor vehicle which is, in particular, a motor vehicle controlled by the driver themselves (“driver only”), a semi-autonomous, autonomous (for example, of autonomy level 3 or 4 or 5 (of standard SAE J3016)), or a self-driving motor vehicle. The autonomy level 5 describes fully automatic vehicles. Equally, the vehicle may be a driverless transport system. The vehicle may, in this case, be controlled by a driver or drive autonomously. Moreover, in addition to a road vehicle, the vehicle may also be an air taxi, an airplane, and another means of locomotion or another type of vehicle, for example an aircraft, watercraft, or rail car.

The present disclosure further relates to a computer program or a computer program product comprising program means, in particular a program code which represents or codes at least some and for example all of the method steps of the method according to the teachings herein, in particular those that are carried out by the light image determination device or the light image generating circuit, and for example one of the described embodiments and is designed for execution by a processor device.

The present disclosure further relates to a data memory on which at least one embodiment of the computer program according to the teachings herein or an embodiment of the computer program is stored.

The present teachings have been described with respect to lighting apparatuses for a vehicle. The present teachings are also applicable to lighting apparatuses for general lighting, lighting apparatuses for aerospace and for consumer electronics. The applicant reserves the right to also claim related subject matter therefore.

Reference will now be made to the drawings in which the various elements of embodiments will be given numerical designations and in which further embodiments will be discussed.

Specific references to components, process steps, and other elements are not intended to be limiting. The FIGS. are schematic and not necessarily to scale.

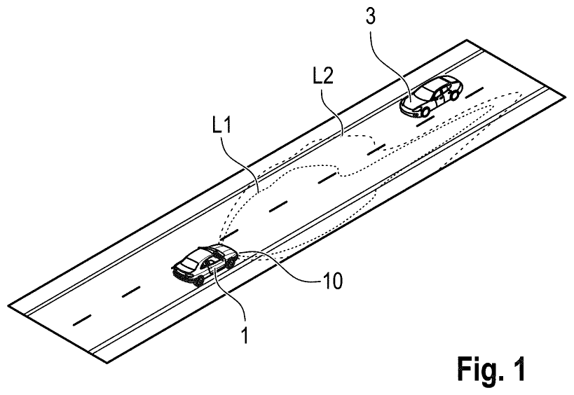

FIG. 1 shows a representation of the use of a lighting apparatus 10 according to the teachings herein, here a headlight, of a vehicle 1 of an embodiment in a traffic situation in which a vehicle 3 is approaching the vehicle 1 on the opposite lane as oncoming traffic.

In order to prevent the driver of the vehicle 3 from being dazzled and at the same time to effectively illuminate the lane to be traveled by the vehicle 1, the lighting apparatus 10 emits, for example automatically, one of the asymmetric light distributions which causes the illumination on the roadway characterized by reference signs L1, L2. The particular emitted light distributions are designed in such a way that they exclude the spatial region of the vehicle's surroundings in which the oncoming vehicle 3 is currently located. Since both vehicles 1, 3 are in motion, the determination and generation of the particular light distribution to be output by the lighting apparatus 10 is a highly dynamic (real-time) process.

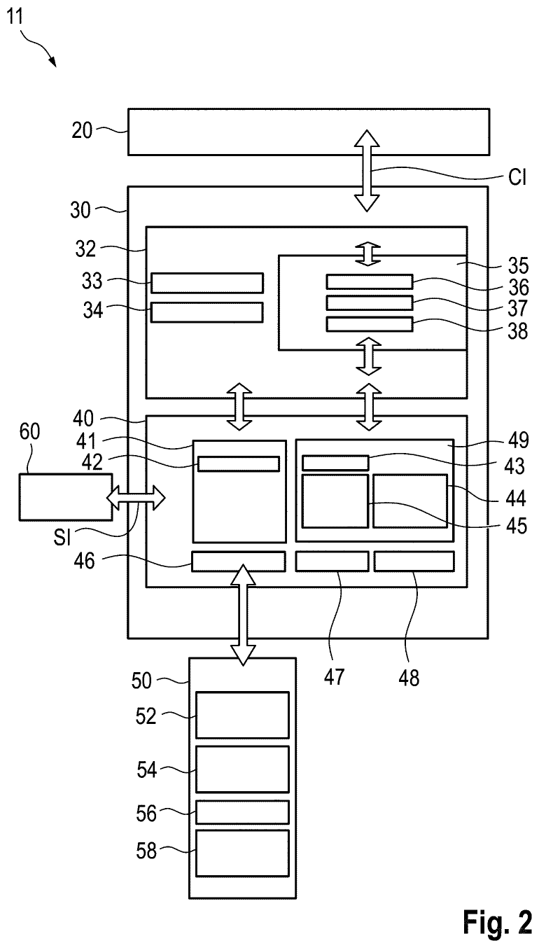

FIG. 2 shows a schematic representation, according to an embodiment, of a control apparatus 11 for a lighting apparatus 10 (not shown here).

The control apparatus 11 comprises (at least) two independently operable computing devices 20, 30 which are for example arranged at a distance from one another.

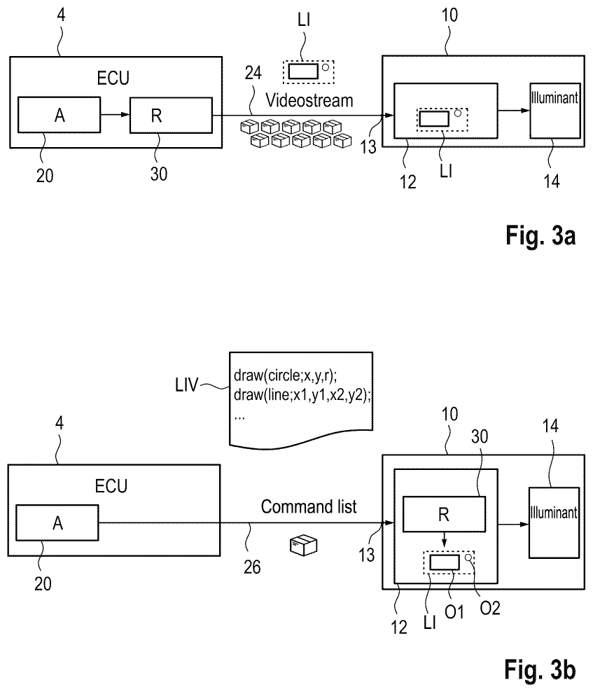

In this case, a computing device external relative to the lighting apparatus 10, namely a remote computer, identified by reference sign 20, is for example provided. This is in particular the above-mentioned (processor- and/or controller-based) light image variable determination circuit 20. The task of this computing device will be described in more detail below within the context of the description of FIG. 3b.

The remote computer 20 or the light image variable determination circuit 20 is arranged in particular outside the lighting apparatus 20 and particularly outside a housing of the lighting apparatus 10. For example, the light image variable determination circuit 20 does not contact the lighting apparatus 10.

The remote computer or the (processor-and/or controller-based) light image variable determination circuit 20 is connected to a further computing device 30, referred to above as the light image generating circuit 30, via a communication interface or a transmission interface CI for exchanging data or for transmitting communication data from the remote computer to the further computing device or to the light image generating circuit 30.

The light image generating circuit 30 for example transmits control variables for actuating the pixels of the lighting apparatus that can be actuated individually. In particular, the control variables are characteristic of the actuation of each pixel of the lighting apparatus to be actuated for emitting light from individual pixels.

This further computing device 30 is for example a renderer computer. For example, the further computing device 30 is an (in particular fixed) component of the lighting apparatus 10 (not shown here). It is conceivable, for example, that the further computing device or the light image generating circuit 30 comprises a housing of the lighting apparatus or is connected to the housing and/or is arranged in the immediate vicinity of the light sources of the lighting apparatus.

Reference sign 32 characterizes a runtime environment. This runs a codec 33, for example an image stabilization 34 and a rendering engine 35. The rendering engine 35 for example comprises a parser 36, convenience functions 37 and a library.

Reference sign 40 characterizes the hardware of the renderer computer 30. This comprises a non-volatile memory device NVM (abbreviation for “non-volatile memory”), denoted here by reference sign 41, in which parameters 42 can be stored, for example.

Another hardware component is a RAM (abbreviation for random access memory), denoted here by reference sign 49. Textures 43 can be stored therein. The RAM may also comprise a frame buffer 45 and a shadow buffer 44.

Furthermore, the hardware 40 for example comprises an interface for a data bus, e.g. SPI (abbreviation for “serial peripheral interface”), denoted by reference sign 46, and for example a video interface 47 and a control interface, denoted by reference sign 48.

For example, the hardware 40 comprises a service interface for communication with a so-called “end-of-line computer” 60 (test computer).

For example, the light image generating circuit 30, here the renderer computer, is suitable and intended to exchange data with an external (relative to the light image generating circuit or the renderer computer) non-volatile memory apparatus (NVM) 50, in particular via the interface 46 for a data bus (e.g. the SPI). This may for example comprise or be stored in a start-up command list 52, a fail-safe command list, textures and/or texture sequences.

FIG. 3a shows a schematic representation of an arrangement of a light image variable determination circuit 20 and a light image generating circuit 30 of a lighting apparatus 10 according to the prior art.

Here, the lighting apparatus 10, for example a high-resolution headlight and/or a floor projector having a plurality of illuminants 14, for example designed as LEDs, can be controlled on a pixel basis via video streaming by an external (relative to the lighting apparatus 10) control unit 4 (ECU, abbreviation for electronic control unit). The video stream is transmitted by the communication device 24 from the control unit 20 to the lighting apparatus 10 via an interface 13, in particular to the light image generating circuit 30 of the lighting apparatus 10, for example to a network node arranged in the lighting apparatus, for example an end point, of a communication network of the vehicle.

The external (relative to the lighting apparatus 10) control unit 4 includes a scene calculation algorithm for the light distribution to be output by the lighting apparatus 10, for example on the basis of sensor data (executed by the schematically shown light image variable determination circuit 20) as well as rendering R for the calculation of the individual images (executed by the schematically shown light image generating circuit 30).

Both the light image variable determination circuit 20 and the light image generating circuit 30 are part of the external (relative to the lighting apparatus 10) control apparatus 4.

The individual light images LI are therefore already transmitted in a spatially resolved or pixel-based manner via video stream from the external (for example central) control unit to the lighting apparatus 10, in particular to an end point 12 of the lighting apparatus 10, which actuates a plurality of illuminants 14, for example LEDs, in particular on a pixel-by-pixel basis, on the basis of the light image LI.

FIG. 3b shows a schematic representation of an arrangement of a light image variable determination circuit 20 and a light image generating circuit 30 of a lighting apparatus 10.

It is proposed to separate the scene calculation algorithm A by the light image variable determination circuit 20 and rendering R of the light image (LI) by the light image generating circuit 30 and placing them on two independent computing units that are connected via a vehicle network or a communication device 26. The lighting apparatus 10 has an interface 13 via which it can receive data transmitted via the communication device 26, such as the at least one light image variable or several light image variables described above.

For this purpose, the scene elements (objects O1, O2) are calculated in an external/central control unit 4 of the vehicle 1 (by the light image variable determination circuit 20) and transmitted via an interface or via the communication device 26, for example as a command list (LIV) via the communication device 26 (for example a vehicle bus, e.g. 10 Mbit Ethernet) to the lighting apparatus 10 or luminaire (for example to the light image generating circuit 30 of the lighting apparatus 10), in particular to a network node (for example an end point 12) of a communication network of the vehicle).

The command list LIV can comprise instructions or commands, for example, regarding which objects are to be created at which position. FIG. 3b indicates the illustrative examples for the commands:
draw (circle; x, y, r):

Draw a circle with center at position x, y and circle radius r
draw (line; x1, y1, x2, y2):

Draw a line from start point x1, y1 to end point x2, y2.

In the lighting apparatus 10, the light image (LI) is calculated (rendered R) from the objects O1, O2 by the light image generating circuit 30 (shown schematically here). This means that the light image LI can be transmitted with low bandwidth requirements and, in particular, regardless of the resolution.

The calculation of the light image LI in the luminaire or lighting apparatus 10 (by the light image generating circuit 30) is for example carried out by software rendering on a microcontroller (MCU), system-on-chip (SoC) or ASIC.

Here, too, on the basis of the generated (spatially resolved) light image LI, the plurality of illuminants 14, for example designed as LEDs 14, are actuated in particular on a pixel-by-pixel basis, and light is emitted by the plurality of illuminants 14 on a pixel-by-pixel basis.

The applicant reserves the right to claim all of the features disclosed in the application documents, provided that they are novel, either on their own or in combination, over the prior art. It should also be pointed out that the individual figures also described features which may be beneficial on their own. A person skilled in the art will immediately recognize that a particular feature described in a FIG. may be beneficial even without adopting further features from that FIG. Furthermore, a person skilled in the art will recognize that benefits can also be obtained by combining several features shown in individual or different FIGS.

### LIST OF REFERENCE NUMERALS

1 Vehicle
3 Oncoming vehicle
4 External control unit
10 Lighting apparatus
11 Control apparatus
12 End point
13 Interface
14 Illuminant, e.g. LED
20 Light image variable determination circuit
A Algorithm
R Renderer
24, 26 Communication device
30 Light image generating circuit
CI Interface
32 Runtime environment
33 Codec
34 Image stabilization
35 Rendering engine
36 Parser
37 Convenience functions
38 Library
40 Hardware
41 Non-volatile storage device
42 Parameter
43 R-textures
44 Shadow buffer
45 Frame buffer
46 Interface for a data bus
47 Video interface
48 Control interface
49 RAM
50 Non-volatile storage device
52 Start-up command list
54 Fail safe command list
56 S-textures
58 S-texture sequences
60 End-of-line computer
SI Service interface
L1, L2 Light distribution
LI Light image
LIV Light image variable
O1, O2 Scene object

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

1. A method for operating at least one luminaire of a vehicle, for outputting a light distribution on the basis of a light image, which is generated, at least regionally by a light image generating circuit of the vehicle, depending on at least one non-spatially resolved light image variable, wherein the at least one light image variable being characteristic of at least one region of the light image to be generated, comprising:
receiving, by the light image generating circuit, the at least one light image variable for at least regionally generating the light image from a light image variable determination circuit of the vehicle that is spaced apart from said light image generating circuit.

2. The method of claim 1, wherein the luminaire comprises the light image generating circuit.

3. The method of claim 1, wherein the light image generating circuit generates the region of the light image using rendering on the basis of the at least one light image variable.

4. The method of claim 1, wherein the at least one light image variable is characteristic of a geometric description of the light image to be generated.

5. The method of claim 1, wherein the light image variable determination circuit determines at least one scene object in order to generate the light image and/or to generate the at least one light image variable.

6. The method of claim 1, wherein the at least one light image variable is characteristic of a command for generating a scene object and/or of a command list for generating a scene.

7. The method of claim 1, wherein the at least one light image variable is transmitted to the light image generating circuit via a vehicle network.

8. A luminaire for a vehicle for outputting a light distribution on the basis of a light image, which is at least regionally generated by a light image generating circuit of the luminaire, depending on at least one non-spatially resolved light image variable, wherein the at least one light image variable being characteristic of at least one region of the light image to be generated, wherein the luminaire has an interface for receiving the at least one light image variable.

9. The luminaire of claim 8, wherein the light image generating circuit is a renderer for carrying out at least one rendering process.

10. The luminaire of claim 8, wherein the light image generating circuit is selected from a group of computing devices which includes microcontrollers, systems-on-chips, ASICs and the like, as well as combinations thereof.

11. An arrangement of a light image generating circuit of a luminaire of claim 8 and a light image variable determination circuit for determining the at least one light image variable, and for transmitting the at least one light image variable to the light image generating circuit, wherein the light image variable determination circuit is arranged outside the luminaire and/or at a distance from the light image generating circuit.

12. The arrangement of claim 11, wherein the light image variable determination circuit and the light image generating circuit can be operated independently of one another.

13. A vehicle, in particular a motor vehicle, comprising at least one luminaire of claim 8 and comprising a light image variable determination circuit for determining the at least one light image variable and for transmitting the at least one light image variable to the light image generating circuit, wherein the light image variable determination circuit is arranged outside the luminaire and/or at a distance from the light image generating circuit.

14. The vehicle of claim 13, wherein the light image variable determination circuit is a computing device of the vehicle.

15. The vehicle of claim 13, wherein the luminaire is a high-resolution luminaire with more than 1,000 pixels for pixel-by-pixel controllable light emission, wherein the vehicle comprises a communication system via which the at least one light image variable can be transmitted to the light image generating circuit, wherein the communication system comprises a CAN bus and/or an Ethernet data connection.

16. The method of claim 1, wherein the at least one luminaire comprises one or more of a headlight and a floor projector of the vehicle.

17. The method of claim 1, wherein the light image is generated in real time.

18. The method of claim 1, wherein the light image generating circuit generates the region of the light image using rendering on the basis of a plurality of light image variables.

19. The method of claim 2, wherein the light image generating circuit generates the region of the light image using rendering on the basis of the at least one light image variable.

20. The method of claim 2, wherein the at least one light image variable is characteristic of a geometric description of the light image to be generated.
